(19) United States
(12) Patent Application Publication
(10) Pub. No.: US 2025/0002269 A1
(43) Pub. Date: Jan. 2, 2025

(54) GRIPPER WITH SUCTION NOZZLE

(71) Applicant: De Beers UK Ltd, London (GB)

(72) Inventors: Philip HARRIS, Berkshire (GB); Peter Stanley ROSE, Buckinghamshire (GB); Andrew PORTSMOUTH, Berkshire (GB); Trevor Anthony HARRIES, Buckinghamshire (GB)

(21) Appl. No.: 18/709,429

(22) PCT Filed: Nov. 9, 2022
(86) PCT No.: PCT/GB2022/052837

§ 371 Date: May 10, 2024

(30) Foreign Application Priority Data
Nov. 12, 2021 (GB) 2116311.8

(51) Int. Cl. B65G 47/91

(52) U.S. Cl. CPC B65G 47/917

(57) ABSTRACT

A nozzle for picking up and dispensing an object comprises a body defining a central bore and terminating in an aperture configured to receive the object; a collar substantially surrounding the body, wherein the body is moveable between a retracted position and an extended position with respect to at least a portion of the collar. In the retracted position, the collar extends beyond the aperture by a first distance in the direction of a main longitudinal axis of the body. In the extended position, the collar extends beyond the aperture by a second distance in the direction of the main longitudinal axis of the body; wherein the first distance is greater than the second distance.

### TECHNICAL FIELD

The present invention relates to a nozzle for picking up and dispensing objects. In particular, although not exclusively, the invention relates to a method and a nozzle for picking up and dispensing small objects, for example, melee gemstones.

### BACKGROUND

Reference is made to various techniques for picking up and dispensing small objects, such as gemstones.

### SUMMARY OF INVENTION

According to a first aspect of the invention, there is provided a nozzle for picking up and dispensing an object, the nozzle comprising: a body defining a central bore and terminating in an aperture configured to receive the object; a collar substantially surrounding the body, wherein the body is moveable between a retracted position and an extended position with respect to at least a portion of the collar; wherein, in the retracted position, the collar extends beyond the aperture by a first distance in the direction of a main longitudinal axis of the body; and in the extended position, the collar extends beyond the aperture by a second distance in the direction of the main longitudinal axis of the body; wherein the first distance is greater than the second distance.

The body may be telescopically connected to the collar. The nozzle may be configured to pick up and dispense a small object, said small object having a maximum dimension of 1 mm, preferably between 0.5 mm and 1 mm. In particular, the object may be a small gemstone.

The central bore may be configured to be connected to a pressure source, in use. The pressure source can apply a negative or positive pressure to the aperture for picking up or dispensing objects, respectively.

The nozzle may be biased into the retracted position by a biasing element, wherein the biasing element is one of: a spring, a coil spring, a resiliently deformable material.

The body and the collar may be substantially annular. The collar comprises an upper collar portion and a lower collar portion, wherein the upper collar portion and the lower collar portion are longitudinally separated by a coil spring.

The upper collar portion is optionally configured to move together with the nozzle body and the lower collar portion is optionally configured to be moveable with respect to the nozzle body. The lower collar portion terminates in a tapered end.

The lower collar portion may terminate in a substantially flat end wall.

The aperture may define an outwardly facing surface or set of surfaces adapted to receive the object.

The object may be a gemstone, optionally a cut gemstone.

The surface defined by the aperture may have a substantially v-shaped cross section, and, optionally, wherein an angle of the v-shaped cross section matches the angle between outer surfaces of the cut gemstones.

The apparatus may further comprise an automated arm to which the nozzle is attached; a controller for actuating the automated arm and/or the nozzle attached thereto; and a source of negative and/or positive pressure.

The apparatus may comprise a dispensing surface configured to receive one or more small objects individually dispensed by the nozzle.

The apparatus may comprise a collection area configured to hold one or more small objects to be individually picked up by the nozzle.

According to another aspect there is provided a method of dispensing small objects. The method comprises providing a nozzle comprising a nozzle body, the body defining a central bore therethrough and terminating in an aperture, the body substantially surrounded by a collar and slideably moveable between a retracted position and an extended position with respect to at least a portion of the collar; wherein in the retracted position, the collar extends beyond the aperture by a first distance; and in the extended position, the collar extends beyond the aperture by a second distance; wherein the first distance is greater than the second distance, and wherein the aperture is surrounded by the collar in both the retracted and the extended positions; receiving an object to be dispensed on the aperture; applying a negative pressure to the bore, thereby holding the object on the aperture; with the nozzle in the retracted position, bringing the collar into contact with a surface onto which the object is to be dispensed; actuating the nozzle into the extended position; applying positive pressure to the aperture to dispense the object onto the surface; and actuating the nozzle into the retracted position.

The method may comprise connecting the central bore to a pressure source to apply the negative or positive pressure to the aperture.

The method may comprise biasing the nozzle into the retracted position.

The method may comprise moving an upper collar portion together with the nozzle body and moving the lower collar portion with respect to the nozzle body.

The method may comprise controlling a final location of the object upon the surface by an internal diameter of a tapered end of the collar.

Bringing the collar into contact with a surface onto which the object is to be dispensed with the nozzle in the retracted position, and actuating the nozzle into the extended position, may comprise maintaining a vertical gap between the object and the surface.

Applying positive pressure to the aperture to dispense the object onto the surface may comprise stopping applying the positive pressure prior to actuating the nozzle into the retracted position.

The method may comprise orienting the object prior to receiving the object on the aperture and maintaining the object in the same orientation while dispensing the object onto the surface.

The method may comprise attaching the nozzle to an actuating mechanism and controlling the actuating mechanism to move the nozzle from a collection location at which the object is received to a dispensing location at which the object is dispensed onto the surface.

The method may comprise surrounding the object with the collar while applying the positive pressure.

### BRIEF DESCRIPTION OF FIGURES

FIG. 1 illustrates a nozzle for collecting and dispensing small objects;

FIG. 2 illustrates a cross-section of the nozzle;

FIG. 3 illustrates a cross-section of the nozzle in a retracted position;

FIG. 4 illustrates a cross-section of the nozzle in an extended position;

FIG. 5 illustrates a cross-section of an enlarged portion of the nozzle in the extended position; and

FIGS. 6a and 6b illustrate cooperation between a nozzle body and an outer collar.

### DETAILED DESCRIPTION

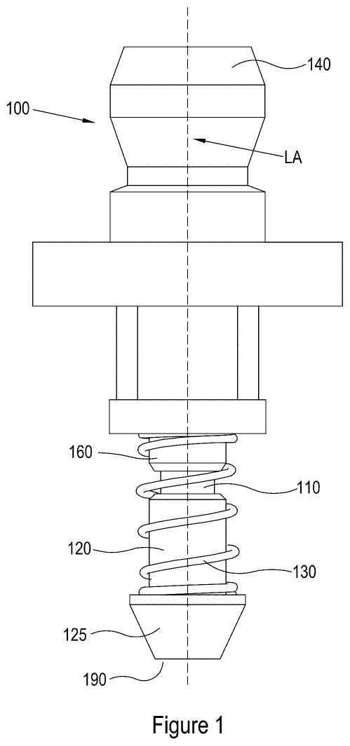

Described herein with reference to FIGS. 1 to 6 are embodiments of a nozzle for picking up and dispensing an object, in particular, a small object. In one embodiment, the nozzle comprises a body defining a central bore therethrough and terminating in an aperture configured to receive the object; a collar substantially surrounding the body, wherein the body is moveable between a retracted position and an extended position with respect to at least a portion of the collar. The nozzle is configured such that, in the retracted position of the body, the collar extends beyond the aperture by a first distance in the direction of a main longitudinal axis of the body; and in the extended position of the body, the collar extends beyond the aperture by a second distance in the direction of the main longitudinal axis of the body; wherein the first distance is greater than the second distance. In one embodiment, the aperture is substantially surrounded by the collar in a radial direction in both the retracted and the extended positions.

The nozzle is configured for collecting (picking up) and dispensing objects, and in particular, small objects such as melee gemstones (e.g., diamonds), although the inventive concept disclosed herein is not limited to gemstones. In one example, a diameter or other maximum dimension of said small objects is between around 0.5 mm to 1.0 mm, optionally between around 0.65 to 0.95 mm. In one embodiment, the diameter or maximum dimension of the small object is less than 0.8 mm. Small gemstones, or small objects in general, pose particular challenges when compared to larger gemstones or other larger objects. For example, the gravitational force on small gemstones may be comparable to the electrostatic force between a gemstone and a surface, which makes the gemstone ‘stick’ to the surface. On the other hand, the gravitational force on a larger object quickly exceeds any electrostatic force between that larger object and a surface of an object used for picking it up, such as a vacuum nozzle.

In the non-limiting example shown in FIG. 1, the nozzle 100 comprises an elongate nozzle body 110; an outer collar comprising upper 160 and lower 120 portions and substantially surrounding the nozzle body 110 in the radial direction; and a coil spring 130 substantially surrounding the outer collar 120, 160. In this example, the lower portion of the outer collar 120 terminates in a tapered end 125 having a substantially flat end wall 190 that extends in a plane generally perpendicular to a main longitudinal axis (LA) of the nozzle 100. The nozzle body 110 and collar portions 120, 160 are generally tubular in form, although they comprise various additional structural features such as a tapered end to enable corresponding functions as described further below.

In this non-limiting example, the upper collar portion 160 is rigidly connected to the nozzle body 110, such that the upper collar portion 160 and the nozzle body 110 move together. In contrast, the lower collar portion 120, including the tapered end 125, is configured to be slideably (e.g., telescopically) moveable with respect to the nozzle body 110 along the main longitudinal axis. Thus, the nozzle is configured to move between a retracted position and an extended position, as will be described in more detail below. In other embodiments not shown here, the upper collar portion is configured to be slideably moveable with respect to the nozzle body.

An upper end 140 of the nozzle 100 can be attached or otherwise connected to an actuating mechanism (not shown), such as an automated or robotic arm. A suitable robotic arm is provided by Asyril SA and/or may be a SCARA type robot, for example. The actuating mechanism can be controlled by a controller (not shown) in order to move the nozzle 100 from one or more collection locations, at which objects to be individually picked up by the nozzle 100 are collected, and one or more dispensing locations, at which objects that have been picked up by the nozzle are dispensed. The dispensing locations may comprise a surface, a collection bin, a conveyor, or the like. A location at which an object is dispensed is generally referred to herein as a dispensing surface.

Movement of the nozzle 100 between the collection and dispensing locations results in transfer or transport of the objects between these locations. In one non-limiting example, an individual object is selected from a plurality of such objects, picked up by the nozzle and transported to a dispensing location, at which or from where one or more properties of the object can be measured or inspected. In another example, the individual object is transported to a dispensing location following measurement or inspection. Hence, the nozzle may form part of a sorting apparatus, measuring apparatus, inspecting apparatus, or the like. A single nozzle or an array of nozzles may be provided.

The nozzle is configured to collect or pick up individual objects i.e., to collect objects one at a time. In some embodiments, the objects are oriented in some way prior to pick up by the nozzle. Where the objects are comprised in a parcel, group, batch, or pile of similar objects, an object to be picked up by the nozzle may be separated in some way from the remaining objects prior to pick up. Imaging systems may be utilised in some embodiments to select or determine which individual object is to be picked up. Alternatively or additionally, an individual object is presented to the nozzle for pick up. Separation devices, such as vibrating hoppers, rollers, cams and oscillators, are utilised in some embodiments to separate an individual object from a group of objects.

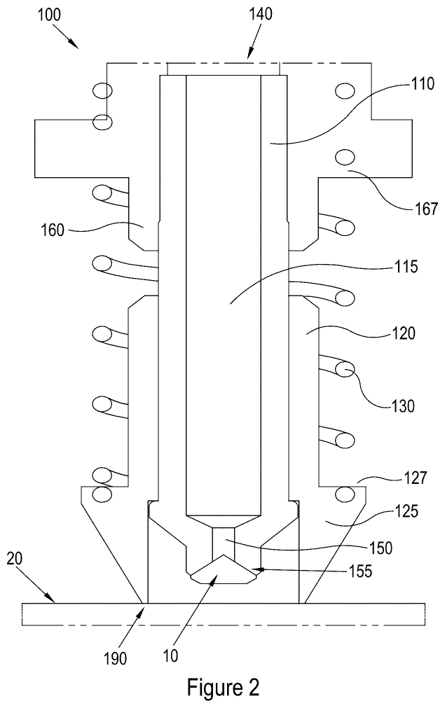

Referring to the non-limiting example illustrated in FIG. 2, the nozzle body 110 defines a central bore 115, through which a vacuum, a negative pressure or a positive pressure (e.g., a puff of air) can be selectively applied via a pressure source. In this respect, a vacuum generator, for example, can be connected to the hollow bore via the upper end 140 of the nozzle 100. The negative pressure is lower than the surrounding atmospheric pressure, while the positive pressure is higher than the surrounding atmospheric pressure. In this example, the bore 115 terminates at a lower end of the nozzle 100 in a receiving aperture 150. The aperture 150 defines an outwardly facing surface or set of surfaces 155 adapted to receive an object 10 to be held on the aperture 155. The surfaces 155 in this non-limiting example are substantially flat and angled, or chamfered (e.g., v-shaped) so as to generally correspond to a culet angle of a cut and polished gemstone 10. The matching shape creates a sealing connection and avoids or reduces a leak path for air, thereby improving the holding force of the nozzle.

Adaption of the shape and size of the aperture and/or the aperture surface(s) for a particular application can assist in ensuring the object is held on the nozzle in a specific position or orientation. This in turn assists in providing precise placement of the object on the dispensing surface. In some applications, precise placement may be a requirement for accurate measurement. For example, the v-shaped aperture surfaces 155 illustrated in the FIG. 2 example assist in central pick up of a cut gemstone 10 in a table-down orientation and prevent the stone 10 from moving while it is held on the nozzle aperture 150. Alternative aperture sizes and configurations—such as curved surfaces, horizontal surfaces, undulating surfaces, gripping surfaces—may be provided for alternative applications.

Referring back to FIG. 2, the tapered end 125 of the lower collar portion 120 defines a protruding shoulder 127, distal to the flat end wall 190. The shoulder 127 provides a flat, annular surface upon which one end of the biasing component—in this example, a coil spring 130—may be connected or affixed. The other end of the biasing component is attached or affixed to a shoulder 167 defined by the upper collar portion 160. In the retracted position, the spring 130 holds the upper 160 and lower 120 collar portions at a distance from one another, as shown in FIG. 2. The nozzle body 110 is received within the upper collar portion 160.

In the retracted position of the nozzle 100, the lower portion of the outer annular collar 120, and in particular the tapered end 125, which tapers inwardly from the shoulder 127, is configured to extend vertically below or beyond the aperture 150, such that the aperture 150 is substantially surrounded by the collar lower portion 120 and the tapered end 125 in a radial direction. Thus, any object 10 held on the nozzle aperture 150 via negative pressure or vacuum applied to the aperture 150 via the bore 115 is also substantially surrounded by the tapered end 125. Said another way, the flat end wall 190 of the tapered end 125 extends longitudinally beyond the aperture 150 in the retracted position.

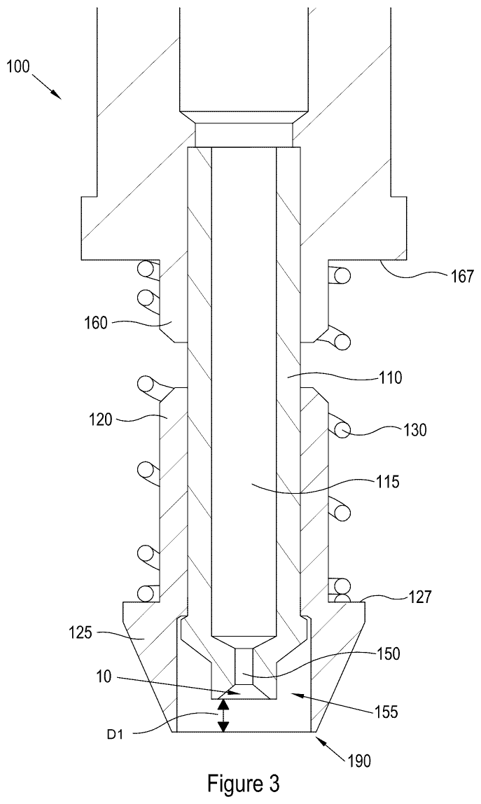

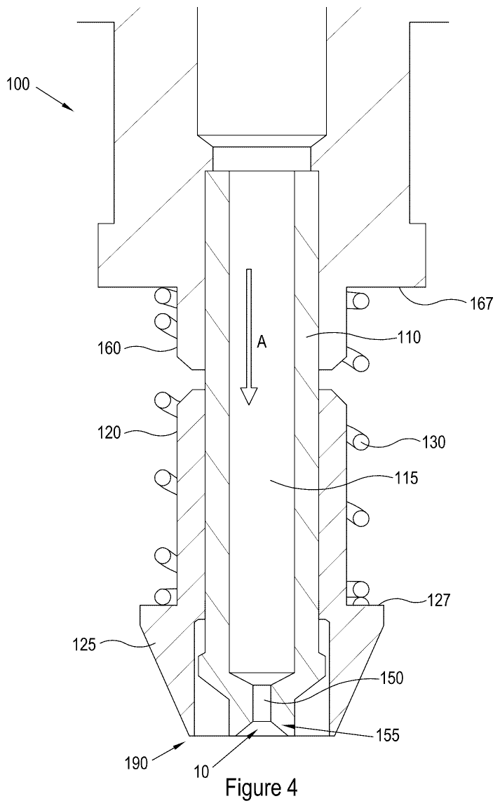

An example of the use of the nozzle 100 to dispense a small object held thereon will now be described with reference to FIGS. 3 and 4. In particular, movement of the nozzle 100 between the retracted position described above, and an extended position, will be described.

In a first actuation step, carried out by the controller (not shown), the lower end of the nozzle 100, i.e., the tapered end 125, is brought into contact with or rests upon a dispensing surface (not shown here for clarity). In some embodiments, the flat end wall 190 of the tapered end 125 is configured for contact with the dispensing surface. In this respect, the flat end wall 190 represents the footprint of the nozzle on the dispensing surface and is configured to minimise said footprint. It will be appreciated that, in the retracted position of the nozzle 100, the object 10 held on the nozzle aperture 150 does not contact the surface (not shown here for clarity), but is held some distance, for example, 0.5 mm, above the surface. In this example, a longitudinal distance between the flat end wall 190 and a lowermost point of the aperture 150 is defined as distance D1 (i.e., a first distance), as illustrated in FIG. 3. Since the flat end wall 190 of the tapered end 125 is in contact with the dispensing surface, a distance between the lowest point of the aperture 150 and the surface is also substantially D1.

In the retracted position illustrated in FIG. 3, the object 10 held on the aperture 150 is therefore enclosed in a space or volume formed by the annular walls of the tapered end 125 and the dispensing surface, with which the flat end wall 190 tapered end 125 is in contact.

The tapered end 125 and/or the flat end wall 190 preferably does not form a seal with the surface, however. Air can flow between an interior and an exterior of the lower collar portion 120. The provision of a pressure differential between the interior and exterior of the lower collar portion 120 can be provided by a leakage path between the nozzle body 110 and the collar 120, 160, and/or can be the result of an aperture provided in the lower collar portion 120.

As illustrated in FIG. 3, in the retracted position of the nozzle 100 the flat end wall 190 of the tapered end 125 of the lower collar portion 120 is in contact with a dispensing surface, following the first actuation step. The uncompressed coil spring 130, which is located between the upper 167 and lower shoulders 127, maintains a vertical gap or space between the upper 160 and lower 120 collar portions. Thus, the tapered end 125 extends beyond the nozzle aperture 150.

As illustrated in FIG. 4, the nozzle 100 is then actuated or controlled by the controller to move further towards the surface (not shown here for clarity), extending in the direction indicated by arrow A, in a second actuation step. This downward motion exerts a longitudinal force on the coil spring 130 via the upper shoulder 167, causing the spring 130 to compress and closing or reducing the gap between the upper 160 and lower 120 collar portions. Since the lower collar portion 120 is already in contact with the surface (not shown), the upper collar portion 160 substantially moves, together with the nozzle body 110, towards the lower collar portion 120 in direction A. Said another way, the lower collar portion 120 and tapered end 125 thereof slides over the nozzle body 110, including the aperture 150, as the nozzle body 110 moves in direction A, extending towards the surface.

As shown in FIG. 4, the nozzle aperture 150 and object 10 held thereon move further towards the dispensing surface (not shown for clarity). In other words, the nozzle 100 moves from the retracted position to the extended position. In this specific context, “retracted” and “extended” refer to the longitudinal position of the nozzle body 110 with respect to the lower portion of the outer collar 120. As discussed above, in the retracted position, a distance D1 exists between the lowest point of the aperture 150 and the flat end wall 190 of the tapered end 125. After the nozzle 100 has been moved into the extended position, this distance decreases to D2 (i.e., a second distance), where D2<D1. The term “retracted” may also refer to an uncompressed position of the nozzle and the term “extended” may refer to a compressed position of the nozzle.

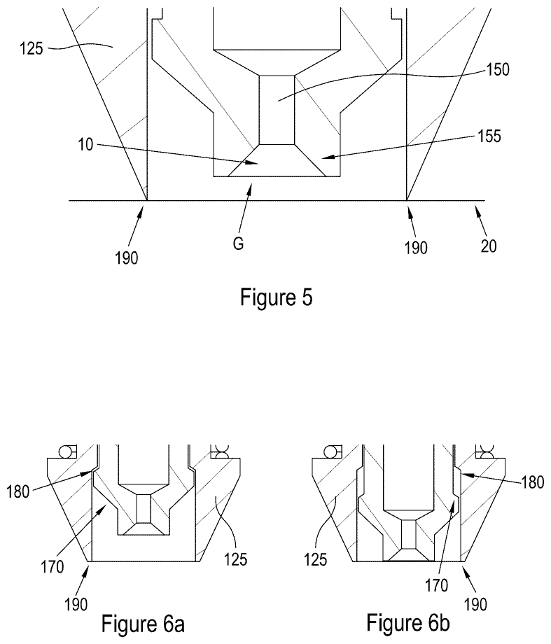

The object 10 is still not brought into direct contact with the surface while it is held on the pick-up nozzle, however. In this non-limiting example, a vertical gap G remains between the object 10 and the surface 20, as illustrated in FIG. 5. Maintaining a gap G between the object and the surface may prevent the object “sticking” to the nozzle aperture 150 during the dispensing operation. The extent of this gap G will of course depend upon the size of the object 10 held on the nozzle aperture 150, i.e., the smaller the object, the larger the gap, and the extent of the engagement of the object with the nozzle aperture. As discussed above, small objects can become electrostatically charged during handling/processing, which can lead to the objects becoming prone to unpredictable behaviour and/or “sticking” to surfaces.

In some examples, distance D2 and gap G are substantially the same, depending upon the size of the object and the configuration of the aperture walls.

In one embodiment, gap G is maintained by the provision of a stop within an interior of the upper 160 or lower 120 collar portions. Alternatively or additionally, gap G is maintained and determined by a threaded member (not shown) which allows the longitudinal space between the upper 160 and lower collar portions 120 to be adjusted, or by abutment of the upper collar portion 160 and the lower collar portion 120 as the biasing member 130 is compressed. In some examples, the gap G is maintained at around 0.25 mm by the upper surface of the lower collar portion 120 and the lower surface of the upper collar portion 160.

Referring now to FIG. 5, following the second actuation step the object 10 is held by the nozzle aperture 150, within the aperture walls 155, slightly above the surface 20 and within an interior of the tapered end 125 of the collar lower portion 120. The flat end wall 190 of the tapered end 125 of the collar 120 is held firmly against the surface 20, such that the object 10 cannot pass therebetween. The object 10 may now be removed from the pick-up nozzle 100, for example, by using positive pressure to blow the object 10 off the receiving aperture 150 and onto the surface 20 below. Positive pressure in the form of a “puff” of air can be supplied via the central bore of the nozzle 100.

The final location of the dispensed object upon the dispensing surface 20 is therefore controlled or constrained by an internal diameter of the flat end wall 190 of the tapered end 125 of the collar 120. In one embodiment, the internal diameter (or maximum dimension where the collar is not annular) of the end wall 190 is around 2 mm. The object 10 can be dispensed i.e., may fall or be blown off the nozzle 100 by a “puff” of air (i.e., positive pressure), but any lateral movement of the object upon the surface 20 is constrained to be within an area of the surface 20 corresponding to the inner diameter (or maximum dimension) of the end wall 190. This will be the case even where the object bounces or otherwise moves before settling, following first contact with the surface 20. However, in some embodiments, gap G is configured such that the object 10 remains in the orientation in which it was held by the nozzle 100, after coming to rest upon the dispensing surface 20. Precise placement of the object 10 onto the dispensing surface 20 is thereby enabled, even where the object 10 may be electrostatically charged, as discussed above.

After the object 10 has been dispensed from off the nozzle 100, the nozzle 100 is be actuated or controlled by the controller (not shown) in a third actuation step, to move away from the surface 20, leaving the object 10 behind. As the downward force on the nozzle body 110 is removed, the nozzle 100 moves from the extended position back to the retracted position as the coil spring 130 expands to an uncompressed position. The upper portion 160 of the collar moves away from the lower portion 120, and the nozzle body 110 retracts by sliding longitudinally with respect to the tapered end 125 such that the tapered end 125 once again extends beyond the nozzle aperture 150.

It will be appreciated that although the above describes dispensing of an object already held on the nozzle, similar steps may apply when picking an object up from a collection surface. A difference between pick-up and placement (dispensing) is that at the point of pick-up, a reduced pressure is provided through the nozzle, such that the object is attached and remains attached to the nozzle. When placing the object, the nozzle is sent to its placement location and once there, a split second of positive air pressure may be applied to the nozzle to ‘blow’ the small object off the nozzle and onto the dispensing surface. In this respect, the lower collar prevents the positive air pressure from causing the object to move too far from its intended location on the dispensing surface. The positive air pressure is stopped or cut off before the nozzle is retracted to avoid the object being blown beyond the inner circumference of the tapered end 125.

In one example, a total time period between picking up a first object with the nozzle, dispensing this object onto the dispensing surface and returning to the collection location to pick up a second object is around 1 second. A total time period between picking up a first object and dispensing (placing) that first object onto the dispensing surface is around 0.5 seconds.

In one embodiment, the nozzle body 110 is provided with a protrusion 170, which is configured to cooperate with a corresponding recess 180 on an interior of the tapered end 125. The protrusion 170 and recess 180 cooperate to prevent the nozzle body 110 from retracting too far within the collar lower portion 120. Cooperation of the protrusion 170 and recess 180 are illustrated in the cross-sections shown by FIGS. 6a and 6b.

In one embodiment, the tapered end 125 of the nozzle 100 is provided with a coating or surface to minimise wear of the dispensing surface 20 during contact.

In one embodiment, alternative biasing components are provided in place of or in addition to the coil spring. For example, a resiliently deformable material may be used.

Although the inventive concept disclosed herein has been described with reference to objects such as gemstones (in particular gemstones of between 0.1 to 0.3 points), the inventive concept is not limited thereto. In other examples, the nozzle herein described may be used for collection and/or dispensing of small objects such as screws, seeds, grains, electronic components, and the like.

The nozzle described herein is configured such that any suitable small object (e.g. an object having a maximum dimension of 1 millimetre or less) can be collected, transported and dispensed precisely, such that the location of the object upon the dispensing surface is known to within around 2 mm. Precise placement of the object upon the surface enables accurate measurement of one or more properties of the object, and/or accurate sorting of the object based upon already-measured properties.

It will be appreciated by the skilled person that various modifications may be made to the above-described embodiments, which may be combined without limitation, without affecting the scope of the inventive concept as defined by the claims that follow. For example, one or more features of one embodiment may be substituted for one or more features of another embodiment.

1. A nozzle for picking up and dispensing an object, the nozzle comprising:
a body defining a central bore and terminating in an aperture configured to receive the object; and
a collar substantially surrounding the body, wherein the body is moveable between a retracted position and an extended position with respect to at least a portion of the collar;
wherein,
in the retracted position, the collar extends beyond the aperture by a first distance in a direction of a main longitudinal axis of the body;
in the extended position, the collar extends beyond the aperture by a second distance in the direction of the main longitudinal axis of the body; and
the first distance is greater than the second distance.

2. The nozzle according to claim 1, wherein the body is telescopically connected to the collar.

3. The nozzle according to claim 1, wherein the nozzle is configured to pick up and dispense the object, the object having a maximum dimension of 1 mm.

4. The nozzle according to claim 1, wherein the central bore is configured to be connected to a pressure source.

5. The nozzle according to claim 4, wherein the pressure source is configured to apply a negative pressure or a positive pressure to the aperture.

6. The nozzle according to claim 1, wherein
the nozzle is biased into the retracted position by a biasing element, and
the biasing element comprises: a spring, a coil spring, or a resiliently deformable material.

7. The nozzle according to claim 1, wherein the body and the collar are substantially annular.

8. The nozzle according to claim 1, wherein the collar comprises an upper collar portion and a lower collar portion.

9. The nozzle according to claim 8, wherein the upper collar portion and the lower collar portion are longitudinally separated by a coil spring.

10. The nozzle according to claim 8, wherein the upper collar portion is configured to move together with the body, and the lower collar portion is configured to be moveable with respect to the body.

11. The nozzle according to claim 8, wherein the lower collar portion terminates in a tapered end.

12. The nozzle according to claim 8, wherein the lower collar portion terminates in a substantially flat end wall.

13. The nozzle according to claim 1, wherein the aperture defines a surface facing outward or a set of surfaces adapted to receive the object.

14. The nozzle according to claim 13, wherein the object comprises a gemstone.

15. The nozzle according to claim 14, wherein the surface defined by the aperture has a substantially v-shaped cross section, or an angle of the v-shaped cross section matches an angle between outer surfaces of the gemstone.

16. An apparatus comprising: a nozzle; an automated arm to which the nozzle is attached; a controller configured to actuate the automated arm and/or the nozzle; and a pressure source of a negative pressure and/or a positive pressure, wherein:
the nozzle comprises:
a body defining a central bore and terminating in an aperture configured to receive an object; and
a collar substantially surrounding the body, wherein the body is moveable between a retracted position and an extended position with respect to at least a portion of the collar;
wherein,
in the retracted position, the collar extends beyond the aperture by a first distance in a direction of a main longitudinal axis of the body;
in the extended position, the collar extends beyond the aperture by a second distance in the direction of the main longitudinal axis of the body; and
the first distance is greater than the second distance.

17. The apparatus according to claim 16, further comprising a dispensing surface configured to receive one or more objects dispensed by the nozzle.

18. The apparatus according to claim 16, further comprising a collection area configured to hold one or more objects to be picked up by the nozzle.

19. A method of dispensing objects, the method comprising:
providing a nozzle comprising a body, the body defining a central bore and terminating in an aperture, the body substantially surrounded by a collar and moveable between a retracted position and an extended position with respect to at least a portion of the collar;
wherein; in the retracted position, the collar extends beyond the aperture by a first distance;
in the extended position, the collar extends beyond the aperture by a second distance;
the first distance is greater than the second distance; and the aperture is surrounded by the collar in the retracted position and the extended position;
receiving an object to be dispensed on the aperture;
applying a negative pressure to the central bore to hold the object on the aperture;
with the nozzle in the retracted position, bringing the collar into contact with a surface of the aperture onto which the object is to be dispensed;
actuating the nozzle into the extended position;
applying a positive pressure to the aperture to dispense the object onto the surface; and
actuating the nozzle into the retracted position.

20. The method according to claim 19, further comprising connecting the central bore to a pressure source to apply the negative pressure or the positive pressure to the aperture.

21. The method according to claim 19, further comprising biasing the nozzle into the retracted position.

22. The method according to claim 19,
further comprising moving an upper collar portion of the collar together with the body, and moving a lower collar portion of the collar with respect to the body.

23. The method according to claim 19, comprising controlling a final location of the object upon the surface according to an internal diameter of a tapered end of the collar.

24. The method according to claim 19, wherein bringing the collar into contact with a surface of the aperture onto which the object is to be dispensed with the nozzle in the retracted position, and actuating the nozzle into the extended position, comprises maintaining a vertical gap between the object and the surface.

25. The method according to claim 19, wherein applying the positive pressure to the aperture to dispense the object onto the surface comprises stopping applying the positive pressure prior to actuating the nozzle into the retracted position.

26. The method according to claim 19, further comprising: orienting the object prior to receiving the object on the aperture; and maintaining the object in the same orientation while dispensing the object onto the surface.

27. The method according to claim 19, further comprising: attaching the nozzle to an actuating mechanism; and controlling the actuating mechanism to move the nozzle from a collection location at which the object is received to a dispensing location at which the object is dispensed onto the surface.

28. The method according to claim 19, further comprising surrounding the object with the collar while applying the positive pressure.
